(19) United States
(12) Patent Application Publication
(10) Pub. No.: US 2026/0209042 A1
(43) Pub. Date: Jul. 23, 2026

(54) MELT PROCESS FOR PREPARING CRYSTALLINE OLIVINE CATHODE MATERIAL FROM VARIABLE COMPOSITION SOURCES

(71) Applicant: IGNIS LITHIUM INC., La Prairie (CA)

(72) Inventors: Michel GAUTHIER, La Prairie (CA); Pierre SAURIOL, Mississauga (CA)

(21) Appl. No.: 19/140,450

(22) PCT Filed: Jan. 9, 2024
(86) PCT No.: PCT/CA2024/050019

§ 371 Date: Jun. 18, 2025

Related U.S. Application Data
(60) Provisional application No. 63/479,266, filed on Jan. 10, 2023.

(51) Int. Cl. C01B 25/30; H01M 4/02; H01M 4/131; H01M 4/36; H01M 4/58; H01M 4/62; H01M 10/54

(52) U.S. Cl. CPC C01B 25/30; H01M 4/131; H01M 4/366; H01M 4/5825; H01M 4/625; H01M 10/54; C01P 2002/72; C01P 2004/80; C01P 2006/40; H01M 2004/028

(57) ABSTRACT

There is provided a two-step melt process for preparing a lithium metal phosphate (LiMPO₄) cathode material having a defined composition. The process comprises first and second melt steps and an intermediary analysis step between the two melt steps. The first melt step comprises mixing reaction precursors to form a first melt pool having a first melt pool composition. The second melt step comprises adjusting the first melt pool composition based on results obtained from the intermediary analysis step such as to obtain a second melt pool having the defined composition. The reaction precursors comprise Li-, M-, P-containing materials, spent cathode materials from used batteries, out of specification (off-spec) cathode materials, and combinations thereof, M being at least one transitional metal. The second melt step and the intermediary analysis step may be repeated a number of times, as desired, until the defined composition is obtained.

### CROSS-REFERENCE TO RELATED APPLICATIONS

The present application claims the benefit of U.S. Provisional Patent Application No. 63/479,266 filed on Jan. 10, 2023. The content of this application is incorporated herein in its entirety by reference.

### FIELD OF THE INVENTION

The present invention relates generally to melt processes for preparing a cathode material. More specifically, the invention relates to a two-step melt process for preparing a lithium metal phosphate (LiMPO₄ wherein M is at least one transitional metal) cathode material having a defined composition. The process according to the invention comprises an intermediary step between the two melt steps. Reactants used in the process may comprise Li-, M-, and P-containing materials as well as spent cathode materials from used batteries and out of specification (off-spec) cathode materials from manufacturing plants.

### BACKGROUND OF THE INVENTION

Lithium metal phosphate (LiMPO₄ wherein M is at least one transitional metal) cathodes have become the cathodes of choice for most energy storage and electric transportation devices. Indeed, LiMPO₄ cathodes present advantageous intrinsic properties, such as thermal and chemical stability as well as long life cycle. The production cost of a LiMPO₄ cathode must be reduced as much as possible, particularly since it still represents more than 20% of the overall production cost of the battery.

Production of lithium metal phosphate olivine cathode materials relies widely on available elements such as Fe, Mn, P (as PO₄), and Li (when recycled). This renders favorable the goal of lowering the production cost. However, high production costs remain associated with the chemical precursors currently used as well as the processes used to make commonly known lithium metal phosphate cathodes such as LiFePO₄ (LFP) and LiFeₓMn₁₋ₓPO₄ (LFMP). Indeed, battery-grade FePO₄, LiOH, and Li₂CO₃ precursors must be well-defined, pure, and fine-sized when used as reactants in solid-state or solvent-assisted precipitation syntheses.

Typically, for most existing solid-state and solvent-assisted precipitation syntheses described to make electrochemically active lithium metal phosphate cathodes, the composition is adjusted by controlling the chemical nature, purity, and proportions of the inputs including lithium, transition metal, and phosphate (WO 02/27823 A1, WO 02/27824 A1, and WO 02/083555 A2). This input control required for solid-state and most solvent-assisted precipitation syntheses has also been applied to recently disclosed melt processes (WO 05/062404 A1, WO 2013/177671 A1, WO 2015/179972 A1). However, there is a cost associated with the requirement to use well-defined reactant compositions in predetermined proportions to control the optimal final composition.

There is a need for processes that allow for the preparation of lithium metal phosphate cathode materials having a desired final composition. There is a need for such processes that are efficient and cost effective.

### SUMMARY OF THE INVENTION

The inventors have designed and developed a two-step melt process for preparing a LiMPO₄ (wherein M is at least one transitional metal) cathode material having a defined composition. The process comprises first and second melt steps leading to first and second melt pools, respectively, and an intermediary analysis step between the two melt steps. The second melt step and the intermediary analysis steps may be repeated a number of times, as desired, until the defined composition is obtained. Reactants used in the process may comprise Li-, M-, and P-containing materials as well as spent cathode materials from used batteries and out of specification (off-spec) cathode materials from manufacturing plants.

In embodiments of the invention, the process further comprises post-synthesis steps comprising subjecting the second melt pool to a casting, solidification, and comminution process as well as a coating process using an electrochemically active material.

In embodiments of the invention, the first melt pool composition, as determined by the intermediary analysis step, may be found to be P-deficient and/or Li-deficient and/or in excess of M and/or indicate the presence of undesired elements. And the second melt step may comprises adding a P-containing material to the first melt pool and/or adding a Li-containing material to the first melt pool and/or adding a M-containing material to the first melt pool and/or injecting a gas stream in the first melt pool and/or extracting the undesired elements from the first pool. Such extraction may also be performed on the second melt pool.

In embodiments of the invention, the reaction precursors may comprise a spent cathode material from used batteries or an off-spec cathode material. And the first melt pool composition, as determined by the intermediary analysis step, may comprise undesired elements. The second melt step may thus comprise extracting the undesired elements from the second melt pool. In such embodiments, a preliminary step may be conducted prior to conducting the first melt step, which comprises subjecting the material to burning to remove any carbon material present in the spent cathode material or the off-spec cathode material.

In embodiments of the invention, the reaction precursors may comprise a material containing a first metal M1 (M1-containing material), and the second melt step may comprise adding a material containing a second metal M2 (M2-containing material) to the first melt pool. In embodiments of the invention, M1 may be Fe and M2 may be Mn.

In embodiments of the invention, the intermediary analysis step to determine the first melt pool composition may comprise using a rapid analysis technique commonly used in the art or a combination of such techniques. In other embodiments, the intermediary analysis step may comprise using an online gas analyzer such as FTIR or MS.

In embodiments of the invention, there is provided the LiMPO₄ cathode material obtained by the process according to the invention, which may be LiFePO₄, LiFe₁₋ₓMnₓPO₄ in which x varies between 1 and 0, or LiMnPO₄.

In embodiments of the invention, there is provided a battery having a cathode which comprises the LiMPO₄ cathode material obtained by the process according to the invention.

In embodiments of the invention, there is provided a cathode or battery manufacturing plant, which embodies the process according to the invention.

The invention thus provides the following in accordance with aspects thereof:
(1) A two-step melt process for preparing a lithium metal phosphate (LiMPO₄) cathode material having a defined composition, the process comprising first and second melt steps and an intermediary analysis step between the two melt steps, wherein: the first melt step comprises mixing reaction precursors to form a first melt pool having a first melt pool composition; the second melt step comprises adjusting the first melt pool composition based on results obtained from the intermediary analysis step such as to obtain a second melt pool having the defined composition; the reaction precursors comprise a material selected from the group consisting of Li-, M-, P-containing materials, spent cathode materials from used batteries, out of specification (off-spec) cathode materials, and combinations thereof; and M is at least one transitional metal, optionally the second melt step and the intermediary analysis step are repeated a number of time.
(2) The process according to (1) above, wherein the first melt pool composition, as determined by the intermediary analysis step, is found: P-deficient and/or Li-deficient and/or in excess of M and/or indicates the presence of undesired elements; and the second melt step comprises: adding a P-containing material to the first melt pool and/or adding a Li-containing material to the first melt pool and/or adding a M-containing material to the first melt pool and/or injecting a gas stream in the first melt pool and/or extracting the undesired elements, preferably the undesired elements are metallic elements that are thermodynamically stable at the melt temperature, more preferably the undesired elements include Cu, Ni, and/or Cr, more preferably the undesired elements include Cu, preferably the gas stream comprises CO₂, H₂, N₂, and combinations thereof.
(3) The process according to (1) or (2) above, wherein: the reaction precursors comprise a spent cathode material from used batteries, an off-spec cathode material, or a combination thereof; the first melt pool composition, as determined by the intermediary analysis step, comprises undesired elements; and the second melt step comprises extracting the undesired elements from the second melt pool, preferably through liquid-liquid or liquid-solid phase separation.
(4) The process according to (3) above, further comprising a preliminary step of subjecting the material to burning thereby removing any carbon material, prior to conducting the first melt step.
(5) The process according to (3) or (4) above, wherein the first and second melt pools are each independently subjected to oxidation and/or mechanical separation to remove any carbon material.
(6) The process according to any one of (1) to (5) above, wherein the reaction precursors comprise a material containing a first metal M1 (M1-containing material), and the second melt step comprises adding a material containing a second metal M2 (M2-containing material) to the first melt pool; preferably M1 is Fe and M2 is Mn.
(7) The process according to any one of (1) to (6) above, wherein the first and second melt steps are conducted at first and second temperatures, respectively, and under inert and/or reductive atmosphere, and wherein the first melt pool is kept at the first temperature and inert and/or reductive atmosphere during the intermediary analysis step; preferably the first and second temperatures are each independently between about 800 and about 1300° C., more preferably above 1000° C.; preferably the inert and/or reductive atmosphere comprises use of Ar, CO₂, H₂, N₂, and combinations thereof.
(8) The process according to any one of (1) to (7) above, further comprising post-synthesis steps.
(9) The process according to (8), wherein a first post-synthesis step comprises subjecting the second melt pool to a casting, solidification, and comminution process yielding a material in powder form and with reduced size particles, preferably the size of the particles is in the range of micron, submicron, nano, and combinations thereof.
(10) The process according to (9) above, wherein a second post-synthesis step comprises subjecting the material with reduced size particles to a coating process using an electrochemically active material to obtain an electrochemically active LiMPO₄ cathode material, preferably the electrochemically active material comprises carbon.
(11) The process according to any one of (1) to (10) above, wherein the first and second melt steps are conducted in first and second containers, respectively, and wherein the first and second containers are different or the same.
(12) The process according to any one of (1) to (11) above, wherein the first and second melt steps are each independently conducted with mechanical stirring and/or gas-assisted stirring of the melt pool.
(13) The process according to any one of (1) to (12) above, wherein the first and second melt steps each independently comprises a phase separation or filtration of the melt.
(14) The process according to any one of (1) to (13) above, wherein the metal (M) is Fe or Mn or both Fe and Mn.
(15) The process according to any one of (1) to (14) above, wherein the Li-containing material is selected from the group consisting of: LiOH, Li₂CO₃, Li₂SO₄, Li₃PO₄, LiPO₃, LiH₂PO₄, and a combination thereof.
(16) The process according to any one of (1) to (15) above, wherein the M-containing material is a Fe-containing material and is selected from the group consisting of: Fe⁰, Fe₂O₃, FeO, FeSO₄, a concentrated mineral ore such as hematite and magnetite, and a combination thereof.
(17) The process according to any one of (1) to (16) above, wherein the M-containing material is a Mn-containing material and is selected from the group consisting of: Mn⁰, MnCO₃, MnO₂, Mn₂O₃, Mn₃O₄, MnO, MnSO₄, a concentrated mineral ore such as pyrolusite, rhodochrosite and hausmannite, a manganese-rich alloy such as ferromanganese (Mn+Fe), and a combination thereof.
(18) The process according to any one of (1) to (17) above, wherein the P-containing material is selected from the group consisting of: P₂O₅, Li₃PO₄, LiPO₃, LiH₂PO₄, (NH₄)₂HPO₄, (NH₄)H₂PO₄, and a combination thereof.
(19) The process according to (1) above, wherein the spent cathode materials or the off-spec cathode materials comprise one or more of: carbon-coated LiMPO₄, FePO₄, Li₃PO₄, Li₃PO₄—Li₂SO₄ mixtures, Li—FeOₓ of variable compositions, and Mn-containing compounds.
(20) The process according to any one of (1) to (19) above, wherein the intermediary analysis step comprises using a rapid analysis technique selected from the group consisting of: Electron Diffraction Spectroscopy (EDS), Glow Discharge Mass Spectrometry (GD-MS), Laser-Ablation-Inductively coupled plasma mass spectrometry (LA-ICP-MS), Laser-Induced-Breakdown-Spectroscopy (LIBS), X-Ray Diffraction (XRD), X-Ray Fluorescence (XRF), Inductively coupled plasma mass spectrometry (ICP-MS), Microwave Plasma Atomic Emission Spectroscopy (MP-AES), and a combination thereof.
(21) The process according to any one of (1) to (20) above, wherein the intermediary analysis step comprises using an online gas analyzer to determine the first melt pool composition, preferably the online gas analyzer is FTIR or MS.
(22) The process according to any one of (1) to (21) above, which is continuous or semi-continuous.
(23) The process according to any one of (1) to (22) above, wherein the LiMPO₄ cathode material has an olivine structure.
(24) The process according to any one of (1) to (23) above, wherein the LiMPO₄ cathode material is electrochemically active, preferably the LiMPO₄ cathode material is carbon-coated.
(25) A LiMPO₄ cathode material obtained by the process as defined in any one of (1) to (24) above.
(26) The LiMPO₄ cathode material according to (25) above, which is selected from the group consisting of: LiFePO₄, LiFe₁₋ₓMnₓPO₄ in which x varies between 1 and 0, and LiMnPO₄.
(27) A battery, wherein the cathode comprises a material as defined in (25) or (26) above.
(28) A cathode or battery manufacturing plant, which embodies the process as defined in any one of (1) to (24) above.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In the appended drawings:

FIG. 1: XRD Pattern of the sample in Example 1. Olivine structure is found with traces of Li₃PO₄ phase.

FIG. 2: XRD Pattern of the final sample in Example 2. Pure LiFePO₄ structure is found.

FIG. 3: XRD Pattern of the sample in Example 4. Olivine LiFePO₄ structure is visible together with Li₃PO₄ and Li₄P₂O₇ phases.

FIG. 4: XRD Patterns of the sample in step 1 (from Off-Spec material) and the final step after correction (LiFe_{0.5}Mn_{0.5}PO₄) in Example 5.

FIG. 5: XRD Patterns of the samples in step 1 and the final step after correction in Example 7. Large amount of Li₃PO₄ is visible in step 1 whereas pure olivine microstructure is found after correction in step 2.

FIG. 6: A) XRD Patterns of the sample in step 1 (LiMnPO₄) and the final step after addition of off-spec LiFePO₄(LiFe_{0.25}Mn_{0.75}PO₄ ) in Example 8. B) Lattice parameters after the different steps (Step 1: MCDL58-S1) and after correction (i.e., addition of Off-spec LiFePO₄) (Step 2: MCDL58).

FIG. 7a: Picture of the LFP ingot with visible droplets of copper.

FIG. 7b: Picture of the LFP ingot and Ag metal ingot. No traces of copper droplets are visible on the LFP ingot contrary to FIG. 7a from Example 9a.

### DESCRIPTION OF ILLUSTRATIVE EMBODIMENTS

Before the present invention is further described, it is to be understood that the invention is not limited to the particular embodiments described below, as variations of these embodiments may be made and still fall within the scope of the appended claims. It is also to be understood that the terminology employed is for the purpose of describing particular embodiments; and is not intended to be limiting. Instead, the scope of the present invention will be established by the appended claims.

In order to provide a clear and consistent understanding of the terms used in the present specification, a number of definitions are provided below. Moreover, unless defined otherwise, all technical and scientific terms as used herein have the same meaning as commonly understood to one of ordinary skill in the art to which this disclosure pertains.

Use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

As used herein, the term “two-step melt process” in relation to the process according to the invention, refers to a melt process for preparing an LiMPO₄ (wherein M is at least one transitional metal) cathode material having a defined composition. The process comprises two melt steps, identified herein as first and second melt steps; and an intermediary analysis step is conducted between the two melt steps. The process may also have additional steps which are conducted after the second melt step. These additional steps are identified herein as post-synthesis steps and include processes such as casting, solidification, and comminution as well as coating using an electrochemically active material. The terms “two-step melt synthesis process” and “two-step synthesis” are also used herein. Accordingly, the terms “two-step melt process”, “two-step melt synthesis process” and “two-step synthesis” are used interchangeably.

As used herein, the term “out of specification” or its abbreviated form “off-spec” in relation to a product or material, refers to a product or material that does not meet the specification of a manufacturer, i.e., not suitable for use for its intended purpose and thus discarded. For example, the term “out of specification cathode material” or “off-spec cathode material” is used herein to refer to a cathode material from another plant that is considered not suitable for use in a battery. Such material is used in the process according to the invention and its composition is corrected to a desired composition.

The inventors have designed and developed a two-step melt process for preparing an LiMPO₄ (wherein M is at least one transitional metal) cathode material having a defined composition. The process comprises first and second melt steps and an intermediary analysis step between the two melt steps. Each of these steps are described in detail herein.

The present invention further builds on the molten process to make LiMPO₄ cathode compositions having the olivine structure, at a lower cost. In the present disclosure, M in LiMPO₄ represents at least one transitional metal. In embodiments of the invention M is Fe or Mn or both. It has been shown in previous applications that melt synthesis can further optimize manufacturing cost of well-defined LiMPO₄ cathode by its capacity to use a wider range of chemically defined reactants than other more reactant-specific LiMPO₄ synthesis processes (such as solid-state) with the use, for example, of pure Fe⁰, Li₃PO₄, Fe₂O₃ for example as well as the use of concentrated mineral ore like hematite or magnetite, for as long as their chemical composition is stable and known.

The present invention builds on the short reaction time made possible with a liquid melt reaction pool preferably with stirring, and more importantly, on the unique reversibility of the synthesis reaction at thermodynamic equilibrium to correct composition based on a rapid in-situ analysis to adjust to the desired composition to be casted. This not only improves process reliability, but also optimizes yield while allowing different precursors of variable compositions as well as reactants recovered from used battery recycling.

The present invention concerns a more flexible continuous or semi-continuous two-step molten process to make well-defined composition of crystalline olivine cathode materials from a much wider range of reactants that can be composition-variable and that can be directly fed as such in a first molten reactive pool; said cathode material having after said two-step synthesis and after solidification, the olivine structure and a general well-defined composition represented as: LiMPO₄ in which M is at least one transition metal.

The two-step melt process of the invention rests on the use of a first large molten reactive pool in which different Li, M, and PO₄ bearing sources of variable chemical compositions, or not accurately known are fed in their approximate LiMPO₄ proportions and stirred to achieve a first compositional equilibrium, at that point an aliquot is taken from the bath and rapidly analyzed to determine the exact melt elemental composition. Based on this analysis feedback and the molten pool known mass, then in the second melt step, minor amounts of chemically defined Li, M, and P reactants are added in the needed quantities to the pool and stirred again to a new equilibrium so that the melt final composition corresponds to the final desired LiMPO₄ composition before melt casting and solidification.

To the contrary of currently used solid-state and precipitation syntheses for phosphate or oxides cathodes, the speed and more importantly the reversibility of the chemical reactions in the melt state and active melt stirring allow such composition corrections as long as rapid and precise physico-chemical analysis feedback is obtained after step one. It is thus possible during step two to achieve the exact optimal composition of the melt before casting and solidification without a priori having thoroughly defined with great accuracy the composition of every single reactant used in step one either through in-house analyses or through contracted composition certification from the material suppliers. Melt stirring is preferable during both steps given the high specific gravity of solid and liquid reactants and viscosity of some reactants to ensure rapid reaction, equilibrium, and composition reversibility of the melt, including the participation or not of gas phases to the stirring process. Nickel, chromium, and their alloys are thermodynamically stable in the reductive controlled conditions used for the phosphate melt of the invention and can conveniently be used as containment and stirring material as a possible replacement for more fragile and reactive graphite or for most partially soluble ceramic materials. For the same reason, copper is also found stable although liquid over 1084° C. A property that makes possible to separate ionic or metallic copper from the melt as will be shown in the examples. Progressive high density liquid copper separation from the melt can then be followed with the in-situ composition analysis between the invention synthesis steps. Copper separation from the melt as well as other metallic elements thermodynamically stable in the reductive conditions of the process can be separated as a second phase of different density of induced by their solubility in a second liquid metallic phase at the melt temperature such as Ag, Sn, Pb, and Bi for example.

This represents a substantial simplification and cost reduction to make well-defined LiMPO₄ cathode materials from wide range of variable and approximate composition Li, M, PO₄ reactants or combinations of reactants by opposition to precise quantitative measurement of well-defined and reactive chemical reactants. Furthermore, this two-step melt synthesis process makes it possible to use as reactants, out of specification (off-spec) products, process by-products, and even recycled LiMPO₄ cathode from used batteries that now can be used as reactants for step one and composition-corrected during step two. In particular, spent C—LiMPO₄ cathode can also be recovered by burning conductive carbon and eventually some organic cathode binder before or during step one of the process according to the invention.

It is also convenient, but not required, for step two of the synthesis to use well-defined and pure reactants having limited particle size, such as less than 200 μm, for the composition adjustment, since at that point only minor correction are usually required to reach desired LiMPO₄ melt composition. An additional benefit of this two-step melt synthesis process is to allow different temperature, atmosphere, and containment materials when two containers are used, for example a higher temperature at step one to improve kinetic of granular reactants dissolution or a different pO₂ gaseous atmosphere to control LiMPO₄ stoichiometry and the transition metal +2 oxidation state. As an illustrative example, if the source of PO₄ to make LifePO₄ is P₂O₅, a product particularly hygroscopic, great care must be taken usually to avoid PO₄ deficiency in the final product due to water uptake during the reactant storage, manipulation, weighing, and synthesis operation. At step two, based on element analysis, a composition correction becomes possible to compensate any PO₄ deviations incurred during step one. For such reasons, graphite can be used for step one and nickel can be used for step two when two containers are used.

In the same manner, when a reactant source is a concentrate of a natural mineral such as magnetite (a mixture of Fe₂O₃ and FeO) the Fe⁺³/Fe⁺² ratio may vary and must be analyzed frequently. In the same manner, metal iron or manganese can also be used both as a precursor and a source of reduction in conjunction with Fe⁺³ or Mn⁺³⁻⁴ reactants as long as their proportions can be controlled to form LiMPO₄ of the right stoichiometry. Mineral concentrates often contain a few % of residual moisture as a result of their preparation. Such moisture content can vary over time, batch or even within a batch, and must normally be considered when adjusting input ratios, or in the extreme case the moisture must be eliminated by thorough drying of the mineral concentrate prior to use.

In the present invention, these difficulties are addressed by taking advantage of the continuous or semi-continuous process in which a molten pool is used as the reactive media for the reactants as described in WO 2013/177671 A1, but operated differently as a reversible two-step melt synthesis process that is characterized by a first step in which the required composition variable reactants are introduced first in a pool of known mass or volume and stirred to achieve the reaction and a first approximate compositional equilibrium at a given temperature and atmosphere. At that point, the molten pool is held in the liquid-state long enough to allow melt sampling and analysis in order to know at least the exact Li, M, and PO₄ composition. In a second step the pool composition is adjusted to the required chemical composition by adding the minor missing amount of any additional chemically defined reactants, using the analysis data and the known pool mass or volume to be corrected. The further reactant addition is made to the pool that is actively stirred at a temperature and atmosphere condition in order to obtain a new equilibrium at the desired chemical composition and stoichiometry before proceeding to casting and solidification steps.

This two-step met synthesis process can be repeated, if needed, and is followed by additional steps of comminution and particle coating with electrically conducting phase as required to form an electrochemically active cathode material. It is the speed of chemical reaction in the molten pool due to liquid convection, temperature, and stirring, that makes reversible in-situ composition adjustments possible guided by rapid chemical and physicochemical analysis techniques of aliquot from production. A major improvement versus other less flexible phosphate or oxide cathode current solid-state or precipitation production processes.

This in-situ melt feedback in a two-step melt synthesis allows the use of a wider range of chemical sources of variable compositions without the cost associated with fine control of the chemical composition and proportion and other complex manipulation procedures to control incoming reactant stoichiometry. The operation of a continuous or semi-continuous large pool of molten reaction media with a two-step melt synthesis procedure represents a simple and economic way to correct and control the melt composition before casting and solidification thus improving yield and process economic, product quality and eliminating the risk of off-spec batches. Depending on the experimental setup and composition precision required, corrective step two can be repeated to further optimize the control of the final melt pool composition.

Furthermore, with the recent wide acceptance of LiMPO₄-based lithium batteries for most electric vehicle and energy storage applications, not only original cathode and reactants cost is a major contributor (about 20% of battery material cost) but also cathode recycling is becoming an issue for both environment and cost. Not only the invention improves initial cathode production economic, but it also helps used cathode recycling as well as the recycling of off-spec carbon-coated C—LiFePO₄ cathode material from other processes. Presently, it is a challenge to chemically convert C—LiFePO₄ to separate new lithium, metal, or PO₄ reactant sources. Recycling C—LiFePO₄ from end-of-life batteries at random state of discharge or C—LiFePO₄ from off-spec production is possible by introducing these directly in the melt process as a reactant of variable composition with the process of the invention without the need for extensive chemical element separation or a priori characterization. Alternatively, many other partially separated elements from spent LiFePO₄ cathodes recycling such as FePO₄, Li₃PO₄, Li₃PO₄—Li₂SO₄ mixtures or Li—FeOₓ of variable compositions, as well as Mn-containing compounds, can also be used in the present invention as reactants for step one of the invention and composition corrected in step two to form well defined LiMPO₄ including LiFePO₄, LiFeMnPO₄, and LiMnPO₄.

The invention rests on a molten stirred reactive pool process comprising at least two consecutive synthesis steps to make high-quality lithium metal phosphate cathode materials represented by the following general composition: LiMPO₄ in which M is at least one of the following Fe and Mn transition metals. The first synthesis step being used to reach an approximate melt composition from composition variable reactants that is kept hot and preferably molten, while a sampling and physico-chemical analysis is made, and the second step uses minor quantities of chemically defined reactants to fix and equilibrate the final desired composition of the melt based on the result of the physico-chemical analysis made. When the desired melt composition is achieved, the melt is cast, solidified, and converted into an electrochemically active cathode material by known micronization and carbon-coating techniques.

The term general composition in the context of a melt process means that LiMPO₄ composition obtained after solidification may contain a few percent, preferably less than 5% mol. ratio of elements of substitution of the M (such as Ca, Mg, Al, and Si) and P (such as S, B, and Si) elements, as well as secondary crystalline or amorphous phases formed during the solidification process representing less than 5% mol. ratio. Melt synthesis is particularly favorable to addition and substitution in the olivine structure after solidification and the LiMPO₄ composition encompasses such variation as long as the cathode material electrochemical activity is from the olivine structure and not significantly lower than theoretical capacity of 170 mAh/g, preferably >145 mAh/g. As an example, crystalline or amorphous phases including LiPO₃, Li₃PO₄, and Li₄P₂O₇ are frequently induced by adjusting the melt bath composition. In the present invention, one final preferred stoichiometry is often stoichiometric LiFePO₄ or LiMPO₄ plus a 3% mol. excess of LiPO₃. In such a case, any Li, Fe, or P deficiency or excess after step one of the synthesis is corrected in step two by adding the missing elements to reach the desired stoichiometry along with a 0.1-5% mol. LiPO₃ excess.

The melt process of the invention is essentially a two-step continuous or semi-continuous process using a molten pool as a reacting media in which, in a first step, the reactants are introduced into the molten pool, stirred, and reacted at a temperature preferably fixed between about 800 and about 1300° C. and held under the required inert or reductive atmosphere to reach compositional equilibrium to a first approximate LiMPO₄ composition. Such a pool is then held in the molten state preferably for less that 6 hours, more preferably less than 2 hours, and even more preferably less than 1 hour, the time required to conduct precise composition analysis, preferably through aliquot sampling, typically less than 50 g, that are rapidly solidified, cut/ground and analysed by different rapid techniques to determine each element stoichiometry and optionally the crystalline structure or confirmation of the +2 oxidation state of the transition metal. In the second synthesis step, using the exact Li, M, and P element analysis results and the mass or volume contained in the first step reactive pool, the melt composition of the pool is then corrected by adding required amounts of the missing elements, stirring the melt to equilibrium at a temperature and atmosphere composition that can be the same or different from step one in order to obtain the desired final LiMPO₄ melt composition before it is cast, solidified, and ground into a powder form. The reactants used for composition adjustment at step two can be the same as for step one or optionally be of well-defined composition since only minor amounts are required at this step and rapid reaction are sought. It is also part of the invention that the composition correction between step one and step two can address the separation of one or more undesirable elements, such as copper, from the melt usually through liquid-liquid or liquid-solid phases separation as long as the composition analysis step is used to validate correction. Such separation can apply to other metallic elements thermodynamically stable in the reductive conditions of the process, e.g., Ni or Cr included can be separated as a second phase of different density of induced by their solubility in a second liquid metallic phase at the melt temperature such as Ag, Sn, and Pb as shown int the examples. Other non-soluble solid phases could also be phase separated with melt filtration or decantation as could be found when recycling used lithium battery components and controlled by the two-step and melt analysis of the invention.

Although natural convection in the reactive molten pool is favorable to rapid element combination, mechanical and/or gas-assisted stirring of the pool is favored given the different reactant density, viscosity, and the fact that this process can advantageously use coarse reactants such as iron metal particles or iron ore concentrates. Gas stirring can be used, but also mechanical stirrer also such as melt-stable stable nickel or nickel-chromium allows. Depending on the desired melt composition, different gas mixtures can be used over the melt and during casting although inert or buffered gas compositions based on N₂, H₂/H₂O, or H₂/CO₂are preferred, over natural gas, since they are more favorable mixtures for a green economy. The meaning of buffered gas composition refers to a mixture of at least two gases, one oxidizing, the other reducing, such as H₂/H₂O or CO/CO₂ or H₂/CO₂, that can under thermodynamic equilibrium fix the oxygen partial pressure, pO₂, as currently in use in metallurgy (as in the Ellingham curves).

Although the melt reactional pool can be the same for step one and step two, a second, poured-in or liquid-interconnected pool of known mass or volume, can be used advantageously when the temperature and gas composition are chosen different to achieve rapid reaction in the first step and final desired composition equilibrium in the second step. Graphite is one containment material preferred given its inertness vs. chemical reactants and may currently be used for step one and nickel, chromium or their alloys or other high-melting and melt-stable metals can also be used for containment especially when a second container material is used for step two.

The following examples are used to illustrate the procedure of the invention, they may be further optimized as to the crucible nature, heating means and dimensions, and to confirm the reversibility and feasibility of the two-step procedure, the speed of the sampling and analysis techniques as well as the possibility to correct in-situ the melt composition based on aliquot analysis feedback.

Furthermore, it is possible with this invention to use more than one melt container for each step, by pouring part or all melt from one container (the melting container) to the other (the holding container). To minimize element analysis repetition and cost, large melt pools are preferred while rapid analysis techniques such as: Electron Diffraction Spectroscopy (EDS), Glow Discharge Mass Spectrometry (GD-MS), Laser-Ablation-Inductively coupled plasma mass spectrometry (LA-ICP-MS), Laser-Induced-Breakdown-Spectroscopy (LIBS), X-Ray Diffraction (XRD), X-Ray Fluorescence (XRF), Inductively coupled plasma mass spectrometry (ICP-MS), and Microwave Plasma Atomic Emission Spectroscopy (MP-AES). The techniques that can directly be performed on solid/powder samples without the need for digestion or fusion, are preferred to limit energy cost and improve productivity.

In a complementary manner, the possibility to use an online gas analyzer such as FTIR or MS, to determine melt composition through the main components activities could further reduce the dependence on aliquot extraction and preparation, but the results from the gas analysis relate to the liquid composition through either a thermodynamic model or a sufficiently well calibrated interaction matrix. In the present invention, the meaning of an aliquot extraction includes such indirect component activities. Minimally, online gas monitoring should provide a good assessment of the oxidation state of the melt as a result of the CO/CO₂ and/or H₂/H₂O ratios, thus pO₂, that equilibrates the melt. One preferred gas composition to be used for both safety, cost, and toxicity reasons is a N₂, CO₂, H₂ mixture that can be adapted and used for both steps. Alternatively, steam (H₂O) could replace CO₂, as long as its flow can be controlled with sufficient accuracy and condensation can be avoided.

The economic benefit of the invention rests, not only on the wider range of possible Li-, M-, P-and O-bearing reactants that do not require strict composition specification and careful manipulation given the option to make in-situ composition corrections directly in the molten pool before casting, but also on improved productivity of a continuous or semi-continuous process in which rapid equilibrium between reactant and, if needed gas, can be achieved from liquid pool stirring before and after melt sampling and reactant addition. Not only the invention makes it possible to achieve well-defined LiMPO₄ composition from variable reactant compositions, but it also reduces the risk of producing off-spec batches. Furthermore, this two-step melt synthesis, also facilitates the recovery of off-spec production of C—LiMPO₄ from other synthesis processes or eventually makes it possible to recycle C—LiMPO₄ retrieved from end-of-life batteries by using these directly as reactants in the two-step synthesis. In such cases, carbon-coating or conductive carbon powder can be eliminated by oxidation or mechanical separation from the melt. Carbon-coating or conductive carbon powder can also be eliminated in a preliminary step conducted prior to the process according to the invention.

Glass- and steel-making industries offer examples of the different possible containment crucible design and size, their heating means (fossil combustion heating or greener electric inductive, radiative, or resistive heating) and their continuous or semi-continuous casting procedure. Among preferred materials for containment, graphite and oxide, nitride, carbide, boride ceramic, and high temperature melting and melt-stable metals are possible such as nickel, chromium, and their alloys, directly or through self-crucible depending on the heating means selected.

The speed and accuracy of the chemical and physico-chemical analysis is an important factor in the optimisation of the process of the invention since there is a cost associated with holding a large pool of the molten LiMPO₄ before final reactant addition and melt homogenization to the final composition to be cast. The composition analysis of the melt is preferably done through liquid melt sampling followed by rapid casting/quenching (e.g., liquid nitrogen, water, dry ice), and as required cutting/polishing/crushing/grinding to a sample ingot or a fine powder, or in extreme case its dissolution or fusion for rapid element analysis. Although several analytical techniques are possible, the preferred ones are those that will enable measurement on a solid sample, which can be prepared within 5-10 minutes from the moment it is collected in the melt, such technique include: glow discharge mass spectrometry (GD-MS), laser ablation inductively-coupled plasma mass-spectrometry (LA-ICP-MS), laser-induced breakdown spectroscopy (LIBS), X-ray fluorescence (XRF) all of which can provide elemental quantification with measurement times in the minutes range, while X-ray diffraction (XRD) may provide physico-chemical analysis within 1-2 hours for structure determination without high elemental quantification accuracy. Additionally, XRF is not lithium sensitive and does not provide information on lithium quantification. Alternatively, other techniques which require more sample preparation time such as dissolution which may add a few hours to the measurement can also be considered, depending on the holding volume and time, such techniques include: absorption atomic spectroscopy (AAS), inductively coupled plasma optical emission spectroscopy (ICP-OES) and inductively coupled plasma mass spectrometry (ICP-MS), Microwave Plasma Atomic Emission Spectroscopy (MP-AES) since capable to give enough precision and feedback on Li, M, and P or PO₄ element composition within a short period of time, preferably less than 2 hours. Fe⁺²/Fe⁺³ titrations can be used for more complete feedback on melt composition. LECO analyses can complement other analyses techniques providing accurate C content determination within 10 minutes when C—LiMPO₄ is used as a reactant, thus ensuring that the carbon is removed to the required extent prior to casting.

After the composition correction and final homogenization of the melt at a temperature between about 800 and about 1300° C., depending on the melt composition, the liquid phase is partially or totally cast to obtain a solid and crystalline LiMPO₄ with olivine structure. In some case, a phase separation or filtration of the melt can be used as part of step one or at the end of step two before casting depending on the reactive melt composition.

The two-step continuous or semi-continuous synthesis operations can be conducted consecutively in the same container or using more than one container, the first one limited to the crude composition synthesis and the last, liquid-interconnected one or poured-in, whose volume is known to achieve exact final composition adjustment and is used to cast the LiMPO₄. In such a case, interconnection between containers is made by connecting or pouring the melt. Large melt pools are favored to increase productivity, reduce specific energy losses during the thermal hold and cost, as well as the number of analyses required. For high volume and greater precision, the analysis and step two might be repeated.

The ensuing casting, grinding, and carbon-coating steps to obtain electrochemically active LiMPO₄ or C—LiMPO₄ cathode have been described in previous patents (WO 2005/062404 A1, WO 2013/177671 A1, WO 2015/179972 A1) that include melt atomisation, ingot casting, comminution including: crushing, grinding, jet milling, and wet milling to micron-, submicron-, or down to nano-scale primary particles depending on the LiMPO₄ exact composition and requirements at the battery level.

An additional benefit of the invention is to fine tune the melt composition at step two not only to correct for reactant composition variation, but also any eventual losses of reactant by vaporization, spattering, transient FeₓP and FeₓC formation on container walls, container equilibrium effects, delayed reaction rates due to sintering, during synthesis at step one. Moreover, it is also possible not only to correct melt composition to stoichiometry, but also to induce a melt composition that is intentionally off-stoichiometry, for example a slight LiPO₃ excess, so that when an olivine crystalline phase is formed during solidification an intercrystalline LiPO₃ containing phase that can act as an electrically conductive phase is also present. Such phase contributes to better electrochemical behavior of the cathode material as does the usual pyrolytic carbon-coating. In such a case it is preferable in many cases to solidify the melt rapidly by fast casting or atomization quenching to avoid large (several microns) olivine crystal growth and intercrystalline non-olivine phases since comminution to submicron size will form individual non-redox active particles such as LiPO₃, Li₄P₂O₇, Li₃PO₄ since such phases, useful as electrically conductive phase for lithium ion-exchange at the olivine particle surface, do not contribute as such to M⁺²/M⁺³ redox energy storage and are a dead weight penalty. In a useful variant of the invention, the initial molten pool at step one can also be low melting point reactant or combination of reactants only, such as LiPO₃ (melting at about 660° C.) to which the complementary elements are added to reach the desired melt composition, in this case FeO equivalent (such as Fe₂O₃+Fe⁰). Usually with this approach, an excess of LiPO₃ to LifePO₄ stoichiometry is preferred and is fixed at step two based on the chemical element analysis so that a crystalline olivine phase coexist with a LiPO₃ containing phase after casting and solidification.

Agglomeration steps of elementary particles to secondary agglomerates are also part of the invention, such as obtained by spray drying or flash drying preferably before pyrolysis to make conductive carbon-coated C—LiMPO₄, especially LiFePO₄ and Life₁₋ₓMnₓPO₄ with x comprised between 0 and 1.

### EXAMPLES

The following examples using standard laboratory equipment are given to illustrate the mode of operation of the two-step melt process of the invention. It can be transferred to larger scale industrial processes at the kg and ton levels for optimal economic and technical feasibility. The time required for fusion at step one and step two and for analysis at the analysis step, are not optimized for this laboratory demonstration. As will be understood by a skilled person, the time and can be decreased, for example by using mechanical stirring instead of gas stirring. In the same manner, graphite crucible may be advantageously replaced by high melting point and melt-compatible metals such as Ni, Cr, and alloys thereof.

### Example 1

In this example, known amounts of pure Aldrich Fe₂O₃ (Fe⁺³) micron size powder is mixed along with micron size iron powder Fe⁰, (Atomet 1001HP from Rio Tinto QMP, (45-250 μm) in the ratio required to stabilize all iron ions at the Fe⁺² oxidation state. This mixed iron precursor is introduced in a 100 g molten pool of LifePO₄ along with solid P₂O₅ powder (containing 5% mol. water contamination) and Li₂CO₃ powder in the required proportion to form an additional 100 g of stoichiometric LiFePO₄ assuming the added P₂O₅ to be pure (moisture free). The melt is held at 1150° C. by resistive heating in a graphite crucible under a N₂, containing 5% of a H₂/CO₂ to complete reaction at step one. The liquid melt is stirred mechanically during and after reactant introduction into the melt to achieve reaction completion and equilibrium for ½ hour. At this point, about 3 mL of a liquid aliquot of the melt is extracted and poured in a container filled with liquid nitrogen to be ground and dissolved for 4 hours for Li, Fe, and P analysis with standard ICP-MS analysis to determine each element's ratio. As expected, the chemical analysis confirms a deficiency of P vs. Li and Fe. During analysis, the melt is kept at >1000° C. without any excessive crucible corrosion thanks to the reducing atmosphere conditions.

Based on weight measurement of the initial LiFePO₄ pool and the weight of the three reactants introduced, considering the P₂O₅ (P₂O₅+H₂O) as pure, the P-deficient LiFePO₄ melt composition is corrected in step two by adding enough LiPO₃ to the melt in order to correct the P to Fe ratio to 1/1 thus inducing a slight expected excess of Li.

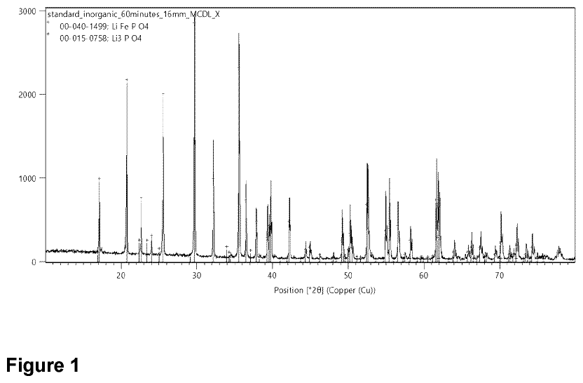

After mechanical melt stirring for an additional ½ hour at the same temperature and atmosphere to complete the step two synthesis, part of the melt is cast, solidified, and ground below 75 μm for XRD and elemental analysis. Chemical analysis of the powder obtained confirms the 1/1 Fe/P ratio while XRD measurement, shown in FIG. 1, confirms the pure olivine structure with traces of a Li₃PO₄ phase.

This example is made from laboratory apparatus only to illustrate the reversibility of the phosphorous-deficient approximative ‘LiFePO₄’ melt composition observed after step one through a second synthesis step guided by the ex-situ melt analysis and thus the feasibility of using a composition variable P₂O₅ reactant to obtain nevertheless well defined LiFePO₄ olivine.

In a large-scale production the melt pool weight measurements could optionally be replaced by melt volume measurements in the same pool container or by pouring part or all the melt after step one into a second pool container of known volume to complete step two.

### Example 2

In this example, the same laboratory procedure used in Example 1 is applied. 100 g of LifePO₄ forms the molten pool to which another 100 g of LifePO₄ is synthesized by introducing a composition variable mixture of lithium precursors made from a mixture of 95% mol. Li₃PO₄ and 5% mol. Li₂SO₄. A mixture that can be obtained for example from spodumene mineral treatment with H₂SO₄ and orthophosphate precipitation. Pure and dry P₂O₅, Fe₂O₃, and Fe⁰ are also added to complete the synthesis of this additional 100 g.

As the Li, Fe, and PO₄ reactant proportion to obtain LiFePO₄ stoichiometry are made considering the Li₂SO₄-contaminated Li₃PO₄ as pure Li₃PO₄, the melt composition after step one is found to be deficient in lithium and PO₄.

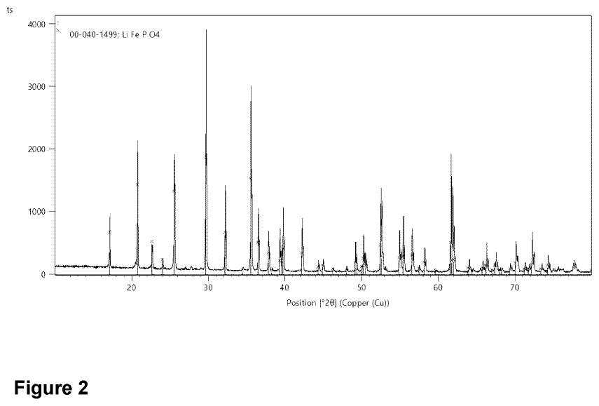

Based on the ICP-MS chemical analysis after step one, the required amounts of LiPO₃ and P₂O₅ are added to the stirred melt for ½ hour under the N₂, CO₂ /H₂ atmosphere of Example 1. After casting, solidification, and grinding the pure LiFePO₄ olivine structure is confirmed by XRD as seen in FIG. 2.

### Example 3

In this example, coarse (~540 μm) powder mixture of iron oxide of approximate Fe₂O₃ composition available from the steel industry and known as ARO (for Acid Regenerated Oxide from Arcelor-Mittal Dofasco) is used to which 5% wt. additional excess Fe₂O₃ is added to simulate an iron reactant of variable composition. Required amount of Fe⁰ powder and LiPO₃ based on the sole ARO composition are also introduced simultaneously in a pool of molten LiFePO₄ stirred by a strong CO₂/H₂/N₂ gas mixture injection at a temperature of 1150° C. to accelerate composition equilibrium. After ½ hour at step one, a sampling and analysis is done as described in Example 1 that confirms the excess of iron in the melt.

In the second synthesis step, additional LiPO₃ is used to correct the Fe-rich melt composition, the temperature is lowered to 1100° C. and the melt is vigorously stirred for 1 hour through CO₂/H₂/N₂ gas injection (5%/5%/90%) to the ‘LiFePO₄’ composition as confirmed by a second analysis. In this case melt stirring is important since iron excess may form FeₓP and FeₓC in the bottom part of the crucible. After equilibrium is obtained the melt is cast, solidified, and ground. An XRD analysis confirms the pure LiFePO₄ olivine structure similar to that in FIG. 2 from Example 2.

### Example 4

In this example, 174 g of an out of specification (off-spec) C-LiFePO₄ containing 10 wt. % C instead of the usual 1.5% C pyrolytic composition optimized for electrochemistry is first oxidized under air at 550° C. to burn all the carbon-coating and form an intimate Fe₂O₃+Li₃Fe₂(PO₄)₃ mixture. This mixture is then treated as a reactant in the process steps of the invention and is progressively introduced in a 158 g pool of molten stoichiometric LiFePO₄(1, 1, 1) composition held at 1150° C. for 1 hour while stirring the melt with a CO₂/H₂/N₂ (5%/5%/90%) reducing atmosphere as in Example 3. At that point two aliquots are taken and analysed, one for LECO analysis to confirm C elimination, the other by standard ICP analysis for Fe, Li, and P content to confirm the exact LiFePO₄ melt composition.

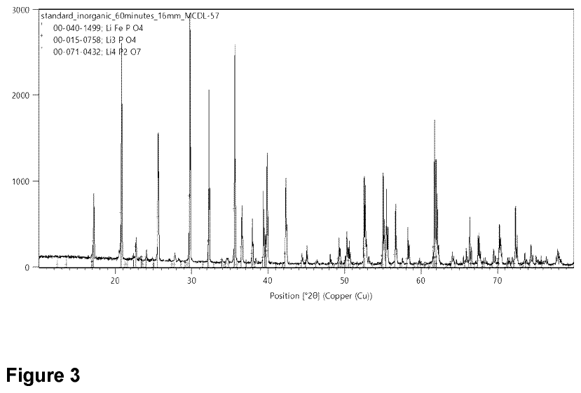

In the second step, the overall melt composition is modified by additional LiPO₃ powder in order not only to recycle the off-spec material, but also to modify the final melt composition to LifePO₄+3% mol. LiPO₃ before casting after stirring for ½ hour at 1150° C. under a CO₂/H₂/N₂ (5%/5%/90%) atmosphere. Structural XRD analysis and microscopic analysis of the ingot obtained confirm the olivine structure of LifePO₄ with some Li₃PO₄ and Li₄P₂O₇ phases probably present in the intercrystalline Li- and P-rich phases observed in the Li_{1.03}Fe₁P_{1.03}O_{4.09} overall composition analyzed in the final product, see FIG. 3.

### Example 5

In this example, another 174 g of the off-spec C—LiFePO₄ material of Example 4 is first oxidized, as previously described, and introduced progressively into a 158 g pool of molten stoichiometric LiFePO₄(1 , 1, 1) composition stirred and held at 1150° C. for ½ hour under a CO₂/H₂/N₂ (5%/5%/90%) reducing atmosphere. At that point two aliquots are taken and analyzed, one for LECO analysis for C to confirm C elimination, the other for Fe, Li, and P elements analysis based on ICP standard analysis to confirm the exact LiFePO₄ melt composition.

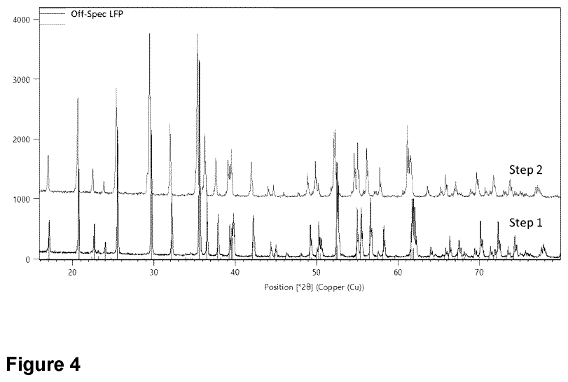

In the second step the overall melt composition is modified to a new different product by introducing 230 g of MnCO₃ and 172 g of LiPO₃ powder to recycle the off-spec C—LiFePO₄ to a new LiFe_{0.5}Mn_{0.5}PO₄ composition as confirmed by XRD analysis from FIG. 4 and cell parameters with a lattice volume of 296.83 Å³ after step two compared to 291.09 Å³ for the material after step one.

### Example 6

To illustrate another variant of the present invention, the molten pool at step one is initially made of a known amount of low melting LiPO₃ held at 1050° C. As part of step one, purified iron ore mineral concentrate from Rio Tinto made of Fe₃O₄—Fe₂O₃ of known but variable composition is mixed with Fe⁰ Atomet powder. The latter is added in order to reach a global FeO approximate composition. This solid mixture is progressively introduced into the melt where LiPO₃ reacts with FeO to form LiFePO₄. Given the inaccurate Fe content, 210 g FeO equivalent is added to 300 g of molten LiPO₃ that is stirred and held under a CO₂/H₂/N₂ (5%/5%/90%) reducing atmosphere. Such an excess is preferred since it avoids solid FeₓP formation.

The elemental analysis at the end of step one confirms the Li and P excess that is then corrected by adding a minor amount of well-defined Fe₂O₃+Fe⁰ mixture. After casting and solidification the pure LiFePO₄ olivine structure is confirmed by XRD, similar to that from FIG. 2 in Example 2, illustrating the flexibility and simplification factor of the two-step process of the invention in terms of reactant selection and process operation.

### Example 7

In this example at a larger scale, approximately 5 kg of off-spec C-LFP powders having excess of Li₃PO₄, as observed by XRD, but otherwise unknown composition is first oxidized under air at 550° C. to burn all the carbon-coating excess and form an intimate Fe₂O₃+Li₃Fe₂(PO₄)₃ mixture. This mixture is then treated as a reactant in the process steps of the invention and is progressively introduced into an induction melting furnace and heated to a melt state at temperature between 1050 and 1100° C. where it is held for 30 minutes to ensure complete melting. A 25 mL aliquot of the melt was collected and rapidly cooled into a liquid nitrogen-cooled stainless-steel mold under argon atmosphere. After 5 minutes, the sample disc's outer surfaces were cold enough (below 100° C.) to be handled under air without risk of oxidation.

An LIBS surface mapping analysis was performed on the flat underside of the sample disc without further sample preparation. A bulk composition confirming the presence of 12.8% (mol./mol.) excess Li and 4.3% (mol./mol.) excess P relative to Fe was determined. The analysis required less than 10 minutes to execute.

Throughout the sample collection/cooling and LIBS analysis, the melt temperature was held near 1050° C. Once the composition from LIBS was obtained, a corrective addition was determined: 0.142 kg of P₂O₅ (microcrystalline, Clariant) and 0.183 kg of Fe₂O₃ (fine ARO, RTC reMuriate) in order to achieve a final composition with 5% excess Li and 3% excess P, the amounts were weighed and co-fed into the hot melt which was held for another 30 minutes with 1:4 H₂/CO₂ bubbling before casting and cooled overnight.

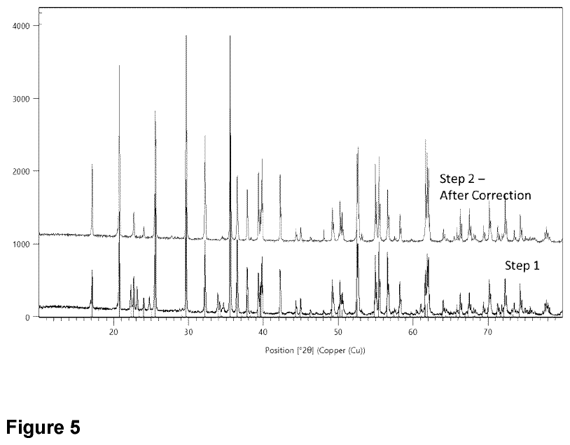

The composition of the final ingot as well as a fragment of the sample disc were later analyzed by XRD and MP-AES. XRD analyses, shown in FIG. 5, qualitatively confirmed the reduction in the Li₃PO₄ between the initial sample and the final ingot and required approximately 1 hour to perform each measurement. The results of the MP-AES were found to be within ±0.3% of the LIBS analyses results and the final ingot was determined to have 6% excess Li and 3% excess P. The time required for the sample preparation (comminution), digestion, and analysis was approximately 4 hours for this non-optimized analysis test.

### Example 8

In this example, LiH₂PO₄ and MnCO₃ in proportions to yield 3.75 kg of stoichiometric LiMnPO₄ were added to a “dirty” graphite crucible which had been previously used for LifePO₄ synthesis and contained unknown amount (approximately 100 g) of residual LiFePO₄ on its surfaces. Step one and intermediary sampling step proceeded as in Example 7.

An LIBS surface mapping analysis was performed on the flat underside of the sample disc. A bulk composition confirming the presence of 0.8% (mol./mol.) of Fe to Mn was determined.

The melt was supplemented with 1.284 kg of off-spec C-LFP, considering the excess Li and P from Example 7, in order to achieve a Life₁₋ₓMₓPO₄ having a 3% (mol./mol.) excess Li and 2% (mol./mol.) excess P and x value of 0.75. Once the off-spec LFP was added, the hot melt which was held for another 30 minutes with argon bubbling before casting and cooled overnight under argon flow.

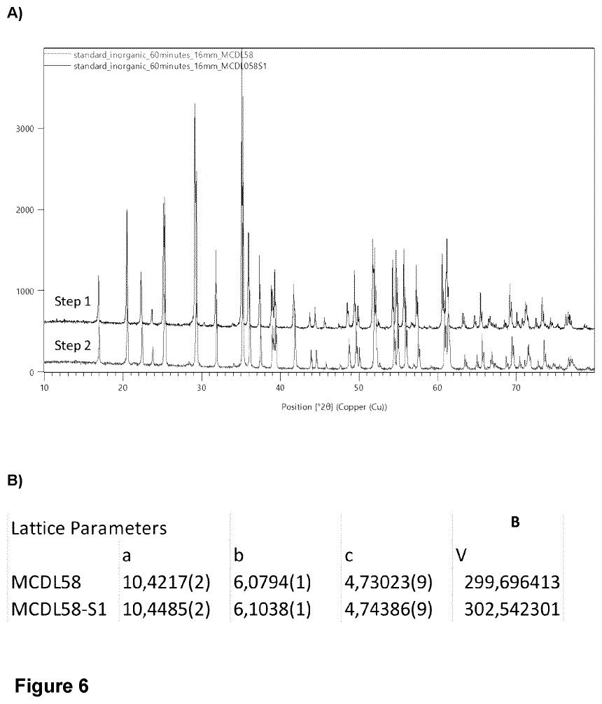

The composition of the final ingot as well as a fragment of the sample disc were later analyzed by XRD and MP-AES, confirming the composition. The XRD patterns in FIG. 6 A) and FIG. 6 B) show the pure microstructures after step one and step two and lattice parameter evolution after correction with the lattice volume decreasing from 302.54 Å³ to 299.70 Å³ after melt composition correction confirming the transition from LiMnPO₄ to LiFe_{0.25}Mn_{0.75}PO_{4.}

### Example 9

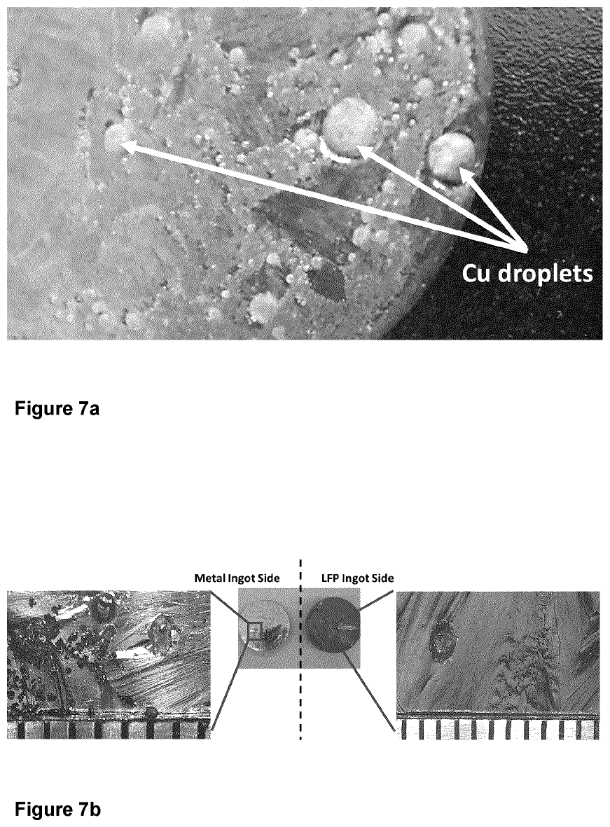

This example aims at illustrating the direct elemental analysis of the melt in the context of purifying and recycling black mass material. In Example 9a, 50 g of 50 g of LiFePO₄ powder from a previous ingot and 1 g of copper (Cu) is added to the powder. The mixture is fed into a graphite crucible capped with a grafoil lid held at 1100° C. for 1 hour. The liquid melt is then slowly cooled inside the crucible under N₂ atmosphere. Interestingly large, concentrated Cu droplets can be found at the bottom of the ingot as shown in FIG. 7a. More interestingly, the resulting ingot only contains 1060 ppm of Cu when 4.4% mol. Cu/mol. LFP was added into the starting mix as determined by MP-AES. This can be explained by the fact that Cu is thermodynamically stable in its metallic state under the reducing conditions of the melt at high temperature and by the fact that copper has a high density of 8.96 g/cm³ compared to that of molten LFP of approximately 2.75g/cm³ . The result is similar for copper chips from copper current collector. Although not optimized, this example shows that a liquid-liquid physical separation of Cu from the melt is possible.

Example 9b is the same as in Example 9a, but a metallic bath of Ag was placed underneath the LFP-Cu starting mixture. 50 g of 50 g of LifePO₄ powder from a previous ingot and 1 g of copper oxide is added to the powder. 150 g of Ag is placed at the bottom of the crucible as impurity trap. The mixture is fed into a graphite crucible capped with a grafoil lid held at 1100° C. for 1 hour. The liquid melt is then slowly cooled inside the crucible under N₂ atmosphere. Once cooled, the LFP ingot can easily be separated from the metallic ingot part. Contrary to Example 9b, Cu droplets cannot be found at the bottom of the ingot as shown in FIG. 7b. Interestingly, the resulting ingot only contains 400 ppm of Cu from MP-AES measurement when 4.4% mol. Cu/mol. LFP was added into the starting mix indicating that most of copper is trapped in the metallic ingot. In the present case, Cu contaminants are extracted from the LFP melt by alloying with the metallic Ag layer. Although not optimized in this example it is shown possible to purify Cu or other metals that are found stable in the melt reducing conditions. This is important for mineral purification as well for phosphate cathode recycling from black mass.

As will be understood by the skilled person, phase separation of Cu metal and molten LFP can easily be performed in the liquid step one. In-situ melt analysis by LIBS or ICP for copper will help determine the time needed to reach the desired Cu residual concentration at step two of the invention.

Throughout the sample collection/cooling and LIBS analysis, the melt temperature can be held near 1050° C. until Cu concentration, as a result of the settling and/or diffusion towards the metallic layer progresses and melt composition drops below a predefined limit.

As will be understood by a skilled person, other variations and combinations may be made to the various embodiments of the invention as described herein above.

While the present disclosure has been described in connection with specific embodiments thereof, it will be understood that it is capable of further modifications and this application is intended to cover any variations, uses, or adaptations including such departures from the present disclosure as come within known or customary practice within the art and as may be applied to the essential features hereinbefore set forth, and as follows in the scope of the appended claims. Features which are described in the context of separate aspects and embodiments of the invention may be used together and/or be interchangeable. Similarly, features described in the context of a single embodiment may also be provided separately or in any suitable sub-combination.

The present description refers to a number of documents, the content of which is herein incorporated by reference in their entirety.

The scope of the claims should not be limited by the preferred embodiments set forth herein above; but should be given the broadest interpretation consistent with the description as a whole.

1. A two-step melt process for preparing a lithium metal phosphate (LiMPO₄) cathode material having a defined composition, the process comprising first and second melt steps and an intermediary analysis step between the two melt steps, wherein:
the first melt step comprises mixing reaction precursors to form a first melt pool having a first melt pool composition;
the second melt step comprises adjusting the first melt pool composition based on results obtained from the intermediary analysis step such as to obtain a second melt pool having the defined composition;
the reaction precursors comprise a material selected from the group consisting of Li-, M-, P-containing materials, spent cathode materials from used batteries, out of specification (off-spec) cathode materials, and combinations thereof; and
M is at least one transitional metal,
optionally the second melt step and the intermediary analysis step are repeated a number of times.

2. The process according to claim 1, wherein the first melt pool composition, as determined by the intermediary analysis step, is found: P-deficient and/or Li-deficient and/or in excess of M and/or indicates the presence of undesired elements; and the second melt step comprises: adding a P-containing material to the first melt pool and/or adding a Li-containing material to the first melt pool and/or adding a M-containing material to the first melt pool and/or injecting a gas stream in the first melt pool and/or extracting the undesired elements,
preferably the undesired elements are metallic elements that are thermodynamically stable at the melt temperature, more preferably the undesired elements include Cu, Ni, and/or Cr, more preferably the undesired elements include Cu,
preferably the gas stream comprises CO₂, H₂, N₂, and combinations thereof.

3. The process according to claim 1, wherein:
the reaction precursors comprise a spent cathode material from used batteries, an off-spec cathode material, or a combination thereof;
the first melt pool composition, as determined by the intermediary analysis step, comprises undesired elements; and
the second melt step comprises extracting the undesired elements from the second melt pool, preferably through liquid-liquid or liquid-solid phase separation.

4. The process according to claim 3, further comprising a preliminary step of subjecting the material to burning thereby removing any carbon material, prior to conducting the first melt step.

5. The process according to claim 3, wherein the first and second melt pools are each independently subjected to oxidation and/or mechanical separation to remove any carbon material.

6. The process according to claim 1, wherein the reaction precursors comprise a material containing a first metal M1 (M1-containing material), and the second melt step comprises adding a material containing a second metal M2 (M2-containing material) to the first melt pool;
preferably M1 is Fe and M2 is Mn.

7. The process according to claim 1, wherein the first and second melt steps are conducted at first and second temperatures, respectively, and under inert and/or reductive atmosphere, and wherein the first melt pool is kept at the first temperature and inert and/or reductive atmosphere during the intermediary analysis step;
preferably the first and second temperatures are each independently between about 800 and about 1300° C., more preferably above 1000° C.;
preferably the inert and/or reductive atmosphere comprises use of Ar, CO₂, H₂, N₂, and combinations thereof.

8. The process according to claim 1, further comprising post-synthesis steps.

9. The process according to claim 8, wherein:
a first post-synthesis step comprises subjecting the second melt pool to a casting, solidification, and comminution process yielding a material in powder form and with reduced size particles,
preferably the size of the particles is in the range of micron, submicron, nano, and combinations thereof; and/or
a second post-synthesis step comprises subjecting the material with reduced size particles to a coating process using an electrochemically active material to obtain an electrochemically active LiMPO₄ cathode material,
preferably the electrochemically active material comprises carbon.

10. (canceled)

11. The process according to any one of claim 1, wherein:
the first and second melt steps are conducted in first and second containers, respectively, and wherein the first and second containers are different or the same; and/or
the first and second melt steps are each independently conducted with mechanical stirring and/or gas-assisted stirring of the melt pool; and/or
the first and second melt steps each independently comprises a phase separation or filtration of the melt.

12. (canceled)

13. (canceled)

14. The process according to any one of claim 1, wherein the metal (M) is Fe or Mn or both Fe and Mn.

15. The process according to any one of claim 1, wherein the Li-containing material is selected from the group consisting of: LiOH, Li₂CO₃, Li₂SO₄, Li₃PO₄, LiPO₃, LiH₂PO₄, and a combination thereof.

16. The process according to claim 1, wherein:
the M-containing material is a Fe-containing material and is selected from the group consisting of: Fe⁰, Fe₂O₃, FeO, FeSO₄, a concentrated mineral ore such as hematite and magnetite, and a combination thereof; and/or
the M-containing material is a Mn-containing material and is selected from the group consisting of: Mn⁰, MnCO₃, MnO₂, Mn₂O₃, Mn₃O₄, MnO, MnSO₄, a concentrated mineral ore such as pyrolusite, rhodochrosite and hausmannite, a manganese-rich alloy such as ferromanganese (Mn+Fe), and a combination thereof.

17. (canceled)

18. The process according to claim 1, wherein the P-containing material is selected from the group consisting of: P₂O₅, Li₃PO₄, LiPO₃, LiH₂PO₄, (NH₄)₂HPO₄, (NH₄)H₂PO₄, and a combination thereof.

19. The process according to claim 1, wherein the spent cathode materials or the off-spec cathode materials comprise one or more of: carbon-coated LiMPO₄, FePO₄, Li₃PO₄, Li₃PO₄—Li₂SO₄ mixtures, Li—FeOₓ of variable compositions, and Mn-containing compounds.

20. The process according to claim 1, wherein:
the intermediary analysis step comprises using a rapid analysis technique selected from the group consisting of: Electron Diffraction Spectroscopy (EDS), Glow Discharge Mass Spectrometry (GD-MS), Laser-Ablation-Inductively coupled plasma mass spectrometry (LA-ICP-MS), Laser-Induced-Breakdown-Spectroscopy (LIBS), X-Ray Diffraction (XRD), X-Ray Fluorescence (XRF), Inductively coupled plasma mass spectrometry (ICP-MS), Microwave Plasma Atomic Emission Spectroscopy (MP-AES), and a combination thereof; and/or
the intermediary analysis step comprises using an online gas analyzer to determine the first melt pool composition,
preferably the online gas analyzer is FTIR or MS.

21. (canceled)

22. The process according to claim 1, which is continuous or semi-continuous;
optionally the LiMPO₄ cathode material has an olivine structure;
optionally the LiMPO₄ cathode material is electrochemically active, preferably the LiMPO₄ cathode material is carbon-coated.

23. (canceled)

24. (canceled)

25. A LiMPO₄ cathode material obtained by the process as defined in claim 1
optionally the LiMPO₄ cathode material is selected from the group consisting of: LiFePO₄, LiFe₁₋ₓMnₓPO4 in which x varies between 1 and 0, and LiMnPO₄.

26. (canceled)

27. A battery, wherein the cathode comprises a material as defined in claim 25.

28. A cathode or battery manufacturing plant, which embodies the process as defined in claim 1.
